(19) United States
(12) Patent Application Publication
(10) Pub. No.: US 2007/0221798 A1
(43) Pub. Date: Sep. 27, 2007

(54) Rotary structure for display base docks

(75) Inventor: Yung-Sheng Lin, Xinzhuang City (TW)

Correspondence Address: BIRCH STEWART KOLASCH & BIRCH, PO BOX 747, FALLS CHURCH, VA, 22040-0747, US

(73) Assignee: Taiwan Thick-Film Ind. Corp.

(21) Appl. No.: 11/389,073

(22) Filed: Mar. 27, 2006

(51) Int. Cl. F16M 11/00; G06F 1/16

(52) U.S. Cl. 248/176.1; 361/681

(57) ABSTRACT

A rotary structure for display base docks includes a bracing seat which has a confining zone and an opening on the confining zone, a rotary dock on one end of the opening that has a coupling portion corresponding to the opening and a confining plate on the other end of the opening. The confining plate has an anchor member to be fastened to the coupling portion. The confining plate is in contact with the rim of the opening to form a confining relationship between the rotary dock and the bracing seat. The coupling portion generates a swivel displacement relative to the bracing seat when the rotary dock is subject to a force. The invention contains fewer elements, can be fabricated and assembled easier, and is steadier.

### FIELD OF THE INVENTION

The present invention relates to a base dock and particularly to a rotary structure for display base docks.

### BACKGROUND OF THE INVENTION

As the technology advances, thin and flat display devices such as LCD or plasma display devices become more popular. The dimension of those flat display devices also is larger. In the past the display device is smaller and lighter. When users want to see the screen in different angles, the display device can be moved and turned directly. Hence the bracing dock does not provide swivel function. However, as the display device becomes bigger and heavier, altering the viewing angle of the entire display device becomes more difficult.

These days the base docks for holding the computer display devices or home appliances such as video phone mostly are designed with swivel function to facilitate adjustment of viewing angle for users. R.O.C. patent publication No. 296886 entitled “Improvement of display rotary dock”, No. 351510 entitled “Rotary LCD screen”, No. 450499 entitled “Rotary dock for securely holding home appliances”, and No. 351511 entitled “LCD screen turnable up and down and swivelable left and right” provide some of the examples of the rotary base dock.

However those base docks still have problems in use, notably:
1. Installing the screen base seat on the rotary base dock is tedious and requires a great deal of manpower.
2. A great number of elements are needed. Material management and fabrication and assembly are difficult.
3. The rotary base dock is quire bulky and against the prevailing trend that demands lean and light. It also requires a lot of materials and the cost is higher.
4. The rotary base dock cannot distribute the weight of the display screen evenly. Shaking occurs during swiveling. It is not stable and requires more efforts from users when in use.
5. It does not have a design to limit the swiveling angle of the display screen. The power cord or signal line tends to be dislocated or entangled in the event of improper operation. Line fracture could happen and result in the risk of fire breakout and severe safety concern.

Thus there is a need to provide a rotary structure to hold display screen to overcome the problems occurred to the conventional rotary base docks that costs less and can be installed easily and used safely.

### SUMMARY OF THE INVENTION

The primary object of the present invention is to solve the aforesaid disadvantages. The invention provides a rotary structure for display base docks that has simplified elements and can save material consumption and reduce production cost.

Another object of the invention is to provide a rotary structure for display base docks that is steadier and more reliable when in use.

To achieve the foregoing objects, the rotary structure of the invention includes a bracing seat which has a confining zone. The confining zone has an opening. There is a rotary dock on one end of the opening. The rotary dock has a coupling portion corresponding to the opening. There is a confining plate on another end of the opening. The confining plate has an anchor member to be fastened to the coupling portion. The confining plate is in contact with the outer rim of the opening to confine the rotary dock and the bracing seat. The coupling portion generates a swivel displacement relative to the bracing seat when the rotary dock is subject to a force. By means of the construction set forth above, the number of elements used in the invention is smaller. Fabrication and assembly are easier, and the structure is steadier. The production cost is lower. It also is more stable and reliable.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 3 is a sectional view of the invention.

FIG. 4 is a schematic view of the invention in an operating condition.

### DETAILED DESCRIPTION OF THE PREFERRED EMBODIMENT

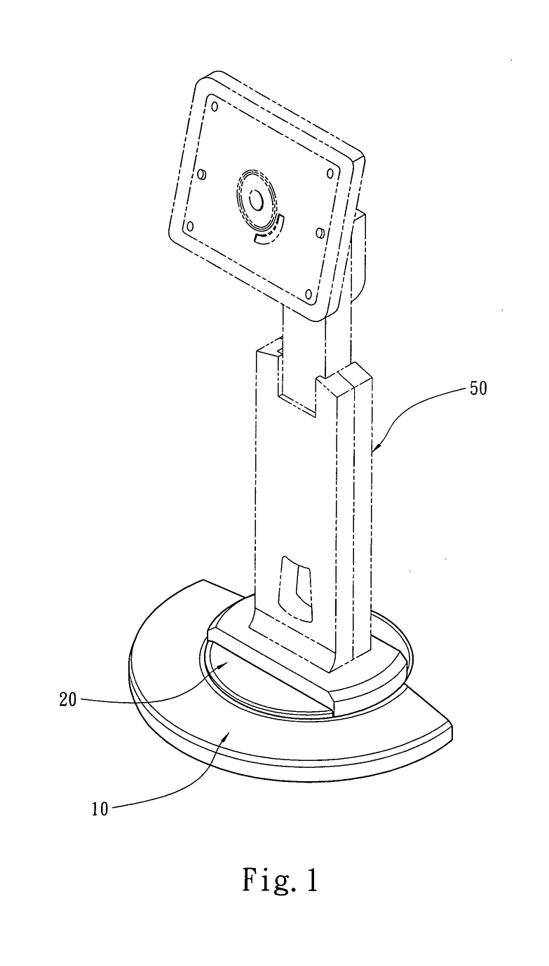

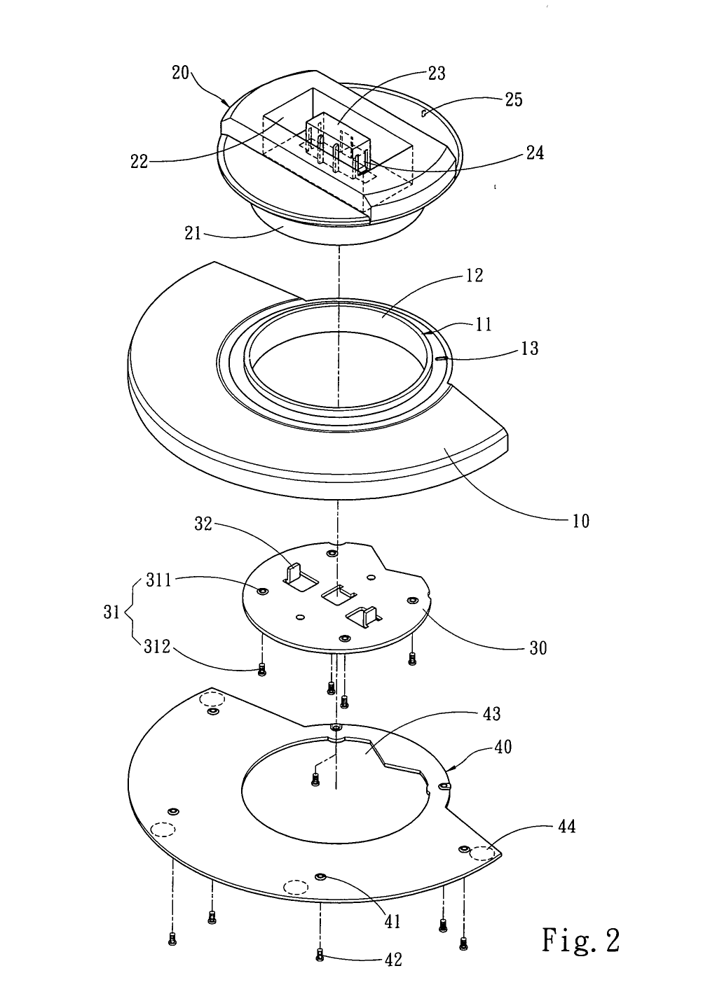

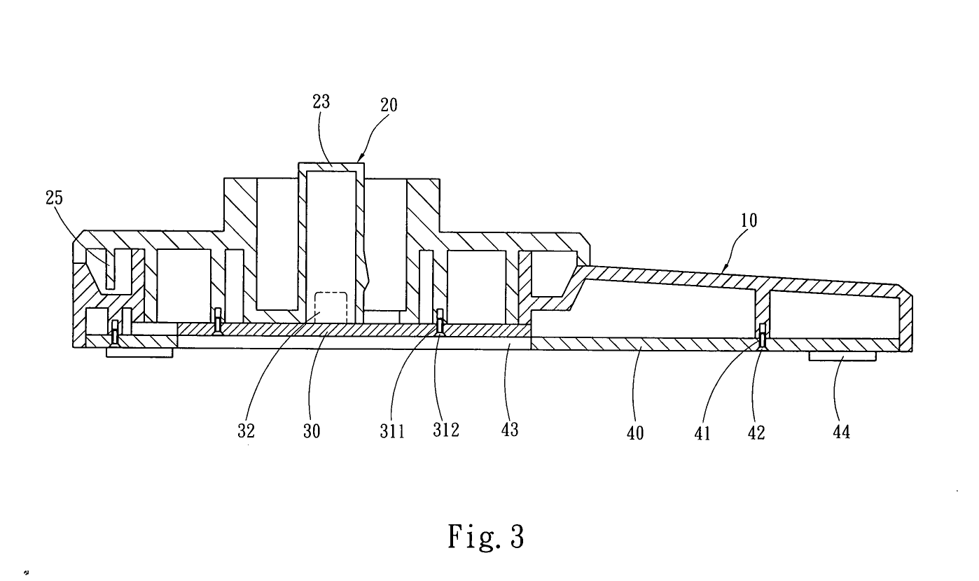

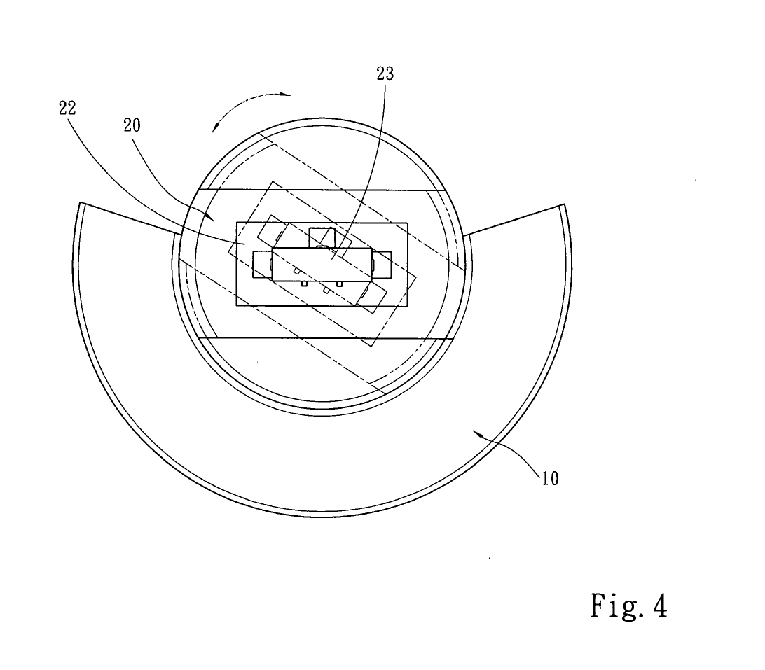

Please refer to FIGS. 1, 2 and 3, the rotary structure for display base docks of the invention includes a bracing seat 10 which has a confining zone 11. The confining zone 11 has an opening 12. There is a rotary dock 20 on one end of the opening 12. The rotary dock 20 has a fastening trough 22 which has an anchor boss 23 to hold a rack 50 to brace a display device (not shown in the drawings). The anchor boss 23 has a harness blade 24 which is elastic and anchored on the rack 50. The anchoring condition of the harness blade 24 on the rack 50 can be released under a force. The rotary dock 20 further has a coupling portion 21 inserting into the opening 12. There is a confining plate 30 on the other end of the opening 12. The confining plate 30 has an anchor lump 32 running through the coupling portion 21 to be fastened to the rack 50. The confining plate 30 further has an anchor member 31 to be fastened to the coupling portion 21. The anchor member 31 includes an anchor hole 311 formed on the surface of the confining plate 30 and a fastening element 312 running through the anchor hole 311. The confining plate 30 is in contact with the rim of the opening 12 to form a confining relationship between the rotary dock 20 and the bracing seat 10. When the rotary dock 20 is subject to a force, the coupling portion 21 generates a swivel displacement (referring to FIG. 4) relative to the bracing seat 10. The bracing seat 10 further has a base board 40 on a lower side to mask the bottom of the bracing seat 10. Such a design can increase the weight and total steadiness. The base board 40 has apertures 41 and screws 42 to fasten to the bracing seat 10. The base board 40 and the confining plate 30 are formed by stamping a same plate material. The base board 40 also has another opening 43 mating the confining plate 30. The confining plate 30 is spaced from the base board 40 at a selected height. Hence when the rotary dock 20 is swiveled under a force, the confining plate 30 is not harnessed by the another opening 43 of the base board 40 and can swivel as desired. The rotary dock 20 and the confining zone 11 further have respectively a brake 25 and a detent portion 13 that are corresponding to each other to limit the swivel displacement to prevent wires from dislocated or entangled under improper operation. The base board 40 may include an anti-slipping rubber pad 44 to enhance steadiness when the invention is rested on a table top.

As previously discussed, the rotary dock 20 is located on one end of the opening 12, and the confining plate 30 is located on the other end of the opening 12. The confining plate 30 is in contact with the rim of the opening 12 to confine the rotary dock 20 and the bracing seat 10. When the rotary dock 20 is subject to a force, the coupling portion 21 can generate a swivel displacement relative to the bracing seat 10. Such a structure requires fewer elements. Fabrication and assembly are easier. The structure also is steadier. Moreover, the base board 40 and the confining plate 30 are formed by stamping the same plate material. The cost is lower and mass production is easier. It overcomes the conventional display base docks that require a great deal of manpower to do assembly and installation, and a greater number of elements that result in more troubles in material management and fabrication. The invention, aside from fewer elements and easier fabrication and assembly, the rotary dock 20 and the bracing seat 10 can form a steadier confining relationship through the confining plate 30. Thus it is more stable and reliable and costs less.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A rotary structure for display base docks, comprising:
a bracing seat which has a confining zone and an opening on the confining zone;
a rotary dock on one end of the opening that has a coupling portion corresponding to the opening; and
a confining plate on other end of the opening that has an anchor member to be fastened to the coupling portion and is in contact with the rim of the opening to form a confining relationship between the rotary dock and the bracing seat; and the coupling portion generating a swivel displacement relative to the bracing seat when the rotary dock is subject to a force.

2. The rotary structure of claim 1, wherein the rotary dock has a fastening trough which has an anchor boss to hold a rack of a display device.

3. The rotary structure of claim 2, wherein the anchor boss has a harness blade to form an anchoring relationship with the rack, the anchoring relationship being releasable when the harness blade is subject to a force.

4. The rotary structure of claim 1, wherein the confining plate has an anchor lump running through the coupling portion to be fastened to the rack.

5. The rotary structure of claim 1, wherein the anchor member includes an anchor hole and a fastening element.

6. The rotary structure of claim 1, wherein the bracing seat has a base board on a lower side that is spaced from the confining plate at a selected height.

7. The rotary structure of claim 6, wherein the base board has apertures and screws to fasten to the bracing seat.

8. The rotary structure of claim 6, wherein the base board and the confining plate are made of a same plate material, the base board having another opening mating the confining plate.

9. The rotary structure of claim 6, wherein the base board has an anti-slipping rubber pad.

10. The rotary structure of claim 1, wherein the rotary dock and the confining zone have respectively a brake and a detent portion that correspond to each other to limit the swivel displacement.
